(19) United States
(12) Patent Application Publication
(10) Pub. No.: US 2008/0060701 A1
(43) Pub. Date: Mar. 13, 2008

(54) Earthquake safety valve for shutting off overflowing gas

(75) Inventor: Yong-Ho Kim, Seoul (KR)

Correspondence Address: BLAKELY SOKOLOFF TAYLOR & ZAFMAN, 1279 OAKMEAD PARKWAY, SUNNYVALE, CA, 94085-4040, US

(73) Assignee: Hucons Technology Co., Ltd.

(21) Appl. No.: 11/520,918

(22) Filed: Sep. 13, 2006

(51) Int. Cl. F16K 17/36

(52) U.S. Cl. 137/38

(57) ABSTRACT

The present invention relates to a valve to shut off an overflowing gas passage and an earthquake safety valve for automatically shutting off a flow passage of LPG, LNG and a poisonous gas; and more particularly, to a valve capable of automatically shutting off the flow passage by sensing an overflowing state of the gas when the overflowing gas is caused by an abnormal increase in gas pressure and by immediately sensing such an earthquake through a mechanical working when an earthquake is generated. The valve automatically closes an inlet or an outlet of the flow passage through a mechanical working based on the fluctuation of the pressure, when the gas exhausted from the gas supply source excessively flows over the regulated amount in an abnormal state.

### FIELD OF THE INVENTION

The present invention relates to a valve to shut off an overflowing gas passage and an earthquake safety valve for automatically shutting off a flow passage of LPG, LNG and a poisonous gas; and more particularly, to a valve capable of automatically shutting off the flow passage by sensing an overflowing state of the gas when the overflowing gas is caused by an abnormal increase in gas pressure and by immediately sensing such an earthquake through a mechanical working when an earthquake is generated.

### DESCRIPTION OF THE RELATED ART

In general, a safety valve has been installed on a gas tube to provide a flowing passage of a fluid which is used as an energy source, such as LPG, LNG, poisonous gas or the like and it shuts off the gas passage, when an earthquake shock or a vibration of a predetermined magnitude is generated and applied to a gas system.

The safety valve is so called a relief valve. This valve keeps the gas pressure in a regulated range, even if the pressure is suddenly and substantially increased in a gas supply source, such as a metallic tube or a hose. In the event of an abnormally high pressure which is caused by an earthquake generation or by a malfunction of the gas supply source, the safety valve operates to exhaust the high pressure gas to an atmosphere until it reaches to the regulated pressure level. However, the safety valve does not have any function to shut off a flow passage, when the gas pressure is rapidly low due to a burst or damage of the tube. The absence of such a function in the safety valve can cause another big accident.

The earthquake sensitive valves are disclosed in U.S. Pat. Nos. 4,715,394, 4,889,150, 4,775,565 and 5,704,385. Also, other example an earthquake sensitive valves for shutting off the gas is disclosed in Korean utility model No. 0,165,104.

These disclosed patents have a structure to shut off an outlet of the flow passage with an inertia ball which moves in a flow passage of a valve body, by mechanically sensing the earthquake shock or the vibration of the predetermined magnitude, which is applied to the gas system. However, these structures are too complex and have low reliance in operation. Since the movement of the inertia ball is dependent upon a rod working or a magnetic force, there is a high probability that a failure to shut off the flow passage is caused by an erroneous manual working or movement toward a closing position of the inertia ball when the earthquake shocks are generated.

In particular, since these structures also operate only when the earthquake is generated, they do not have any devices for sensing an overflowing state of the gas supply source.

### SUMMARY OF THE INVENTION

Accordingly, to solve the above-mentioned problems, an object of the present invention is to provide a safety valve to automatically shut off an inlet or an outlet of a gas passage when an earthquake or an external shock is generated.

Another object of the present invention is to provide a safety valve to automatically and reliably shut off an inlet or an outlet of a gas passage based on the fluctuation of gas pressure in an abnormal state, such as a leakage of the gas.

In accordance with one aspect of the present invention, there is provided an earthquake safety valve to sense an earthquake and overflowing gas and shut off a flow passage comprising: a valve body having an inlet and an outlet of gas and an inner space formed between the inlet and the outlet; an inertia ball positioned on a bottom of the inner space of the valve body in a normal state and moving to the outlet in order to shut off the outlet when the earthquake or a vibration of the predetermined magnitude is generated; a supporting member for supporting the inertia ball on the bottom of the inner space of the valve body; a reset means provided in the inner space of the valve body to get back the inertia ball from a shut-off position of the outlet; and an overflowing gas stopping unit installed in the inlet of the valve body to close the inlet based on overpressure of gas flow, when the gas flow is exhausted over a regulated amount from a gas supply source.

In accordance with another aspect of the present invention, there are provided an earthquake safety valve to sense an earthquake and overflowing gas and shut off a flow passage comprising: a valve body having an inlet and an outlet of gas and an inner space formed between the inlet and the outlet; a lid installed on the valve body and having a working room to put through with the inner space therein; an inertia ball positioned on the upper side of the valve body, moving to the outlet in order to shut off the outlet when the earthquake or a vibration of the predetermined magnitude is generated; a supporting member for supporting the inertia ball on the upper surface of the valve body; a reset means vertically installed in one side wall of the path in which the flow passage of the valve body and inner space of the lid are put through in the vertical direction to get back the inertia ball from the closing position of the flow passage; and an overflowing gas stopping unit installed in the inlet of the valve body to close the inlet based on an overpressure of gas flow, when the gas flow is exhausted over a regulated amount from a gas supply source.

In accordance with further another aspect of the present invention, there are provided an earthquake safety valve to sense an earthquake and overflowing gas and shut off a flow passage comprising: a valve body having an inlet and an outlet of gas and an inner space formed between the inlet and the outlet; a lid installed on the valve body and having a working room to put through with the inner space therein; a middle plate installed over an upper side of the outlet of the valve body to separate the working room from the outlet, wherein the middle plate covers a part of the working room of the lid; an inertia ball positioned on the bottom of the middle plate and moving to the outlet in order to shut off the outlet when the earthquake or a vibration of the predetermined magnitude is generated; a recess for supporting the inertia ball on the bottom of the middle plate; a reset means, one end of which is connected to one end of the middle plate and the other end of which is positioned in the flow passage to get back the inertia ball from a shut-off position of the outlet; and an overflowing gas stopping unit installed in the inlet of the valve body to close the inlet based on an overpressure of gas flow, when the gas flow is exhausted over a regulated amount from a gas supply source.

In the above mentioned embodiments of the present invention, the inlet of the valve body consists of a first hole, a second hole and a third hole in a three-stair structure, wherein a diameter of the first hole is wider than that of the second hole and a diameter of the second hole is wider than that of the third hole.

The overflowing gas stopping unit includes a cylindrical case inserted into the second hole; a blocking member in a shape of cone which area is larger than that of the third hole at one side thereof, having a bar passing through the cylindrical case at the another side thereof so that the blocking member opens or shuts off the inlet through a movement based on the gas flowing pressure; a plug installed at an end of the bar of the blocking member to prevent the blocking member from being released from the cylindrical case; and a first spring surrounding the bar of the blocking member and extended when the gas flow is excessively increased in an abnormal state and making the blocking member disposed at an original position when the gas flow is in a normal state.

In accordance with still another aspect of the present invention, there are provided an earthquake safety valve to sense an earthquake and overflowing gas and shut off a flow passage comprising: a valve body having an inlet and an outlet of gas and an inner space formed between the inlet and the outlet; an inertia ball positioned on a bottom of the inner space of the valve body in a normal state and moving to the outlet in order to shut off the outlet when the earthquake or a vibration of the predetermined magnitude is generated; a magnet installed on the bottom of the inner space, holding the inertia ball through a magnetic force; a driving means installed in the inner space of the valve body, moving the inertia ball toward the outlet; and a reset means installed in the inner space of the valve body, getting back the inertia ball from a shut-off position of the outlet of the flow passage.

The driving means includes: a geared motor clockwise or counter clockwise working by an electrical signal from a gas alarm device, which is installed outside the valve body; and an eccentric shaft making the inertia ball move toward the outlet, located nearby the cylindrical magnet and connected to a shaft of the geared motor, wherein the eccentric shaft is buried in the bottom of the inner space.

The other hand, the driving means can be composed of a solenoid which is installed outside the valve body, wherein the solenoid attracts the inertia ball by generating an electromagnetic force through the electrical signal from a gas alarm device and wherein the inertia ball is made roll toward the outlet by its own weight when the electromagnetic force is faded out.

The above mentioned embodiments of the present invention can further comprises a level installed on an upper surface of the valve body to check the horizontal state of the valve body and a perspective window installed in a front surface of the valve body to check the closed state of the outlet.

### BRIEF DESCRIPTION OF THE DRAWINGS

Other objects and benefits of the present invention will become apparent upon consideration of the following written description taken in conjunction with the following figures:

FIG. 1 is a perspective view illustrating a valve to shut off a flow passage, when an earthquake is caused, according to a first embodiment of the present invention;

FIG. 2 is a front cross-sectional view of FIG. 1;

FIG. 3 is an enlarged cross-sectional view for showing in detail the construct of “A” shown in FIG. 2;

FIG. 4 is a top cross-sectional view taken along the broken line A-A in FIG. 1;

FIG. 5 is a top cross-sectional view taken along the broken line B-B in FIG. 1;

FIG. 6 is a cross-sectional view showing an inertia ball to shut off an outlet of a valve body by sensing an earthquake in the first embodiment of the present invention;

FIGS. 7a and 7b are cross-sectional views illustrating a restore process to return the inertia ball to an original position;

FIG. 8 is a perspective view for illustrating structure of a bracket of a reset unit, in the first embodiment of the present invention;

FIG. 9 is a perspective view illustrating a valve to shut off a flow passage by sensing an earthquake and overflowing gas according to a second embodiment of the present invention;

FIG. 10a is a front cross-sectional view for illustrating the second embodiment of the present invention;

FIG. 10b is a top cross-sectional view taken along the broken line C-C in FIG. 9;

FIG. 11 is an enlarged cross-sectional view for showing in detail the structure of “B” shown in FIG. 10a;

FIG. 12a is a cross-sectional view illustrating a blocking member;

FIG. 12b is a schematic view illustrating the operation of the blocking member;

FIG. 13 is a cross-sectional view illustrating a state, after a reset unit works, according to the second embodiment of the present invention;

FIG. 14 is an enlarged cross-sectional view for showing in detail the structure of “C” shown in FIG. 13;

FIG. 15 is a cross-sectional view illustrating a state, before an inertia ball shuts off a flow passage, according to the third embodiment of the present invention;

FIG. 16 is a cross-sectional view illustrating a state, after the inertia ball shuts off the flow passage, according to the third embodiment of the present invention;

FIG. 17 is a cross-sectional view illustrating a reset state in which a reset unit returns the inertia ball to an original position according to the third embodiment of the present invention;

FIG. 18 is a perspective view for illustrating a structure of a bracket in the third embodiment of the present invention;

FIG. 19a is a cross-sectional view illustrating a state, before the overflowing gas stopping unit shuts off an inlet, according to a fourth embodiment of the present invention;

FIG. 19b is an enlarged cross-sectional view for showing in detail the structure of “D” shown in FIG. 19a;

FIG. 20 is a cross-sectional view illustrating a state, after the overflowing gas stopping unit shuts off the inlet, according to the fourth embodiment of the present invention;

FIG. 21a is an enlarged cross-sectional view for showing in detail the structure of “E” shown in FIG. 20;

FIG. 21b is a perspective view for illustrating a structure of a bracket in the fourth embodiment of the present invention;

FIG. 22 is a perspective view illustrating a valve to shut off a flow passage by sensing an earthquake according to the fifth embodiment of the present invention;

FIG. 23 is a front cross-sectional view illustrating the valve to shut off the flow passage by sensing an earthquake according to the fifth embodiment of the present invention;

FIGS. 24 to 26 are cross-sectional views illustrating a gas blocking mechanism in which an inertia ball moves to a position to shut off an outlet from an original position of a normal state under the regulated pressure;

FIG. 27 is a perspective view illustrating a valve to shut off a flow passage by sensing an earthquake according to the sixth embodiment of the present invention;

FIG. 28 is a top cross-sectional view in FIG. 27; and

FIGS. 29 to 31 are cross-sectional views illustrating a gas blocking mechanism in which an inertia ball moves to a position to shut off an outlet from an original position of a normal state in which the gas flows under the regulated pressure.

### DETAILED DESCRIPTION OF THE PREFERRED EMBODIMENTS

Hereinafter, the present invention will be described in detail referring to the accompanying drawings.

A valve according to the present invention is capable of rapidly and reliably shutting off a flow passage through a mechanical working by sensing an earthquake shock or vibration of the predetermined magnitude and overflowing gas. The overflowing gas is caused by an abnormal increase in gas pressure so that a dangerous accident from the leakage of combustible gas can be generated.

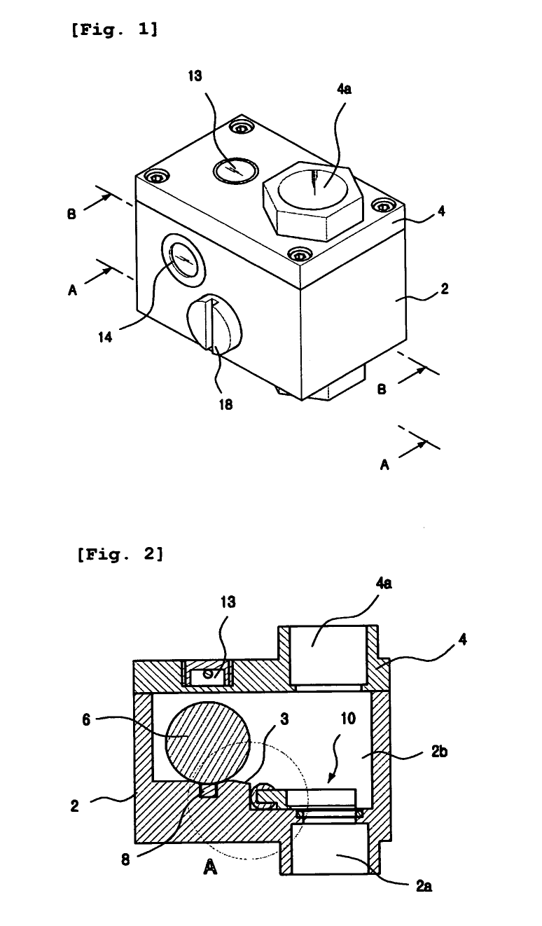

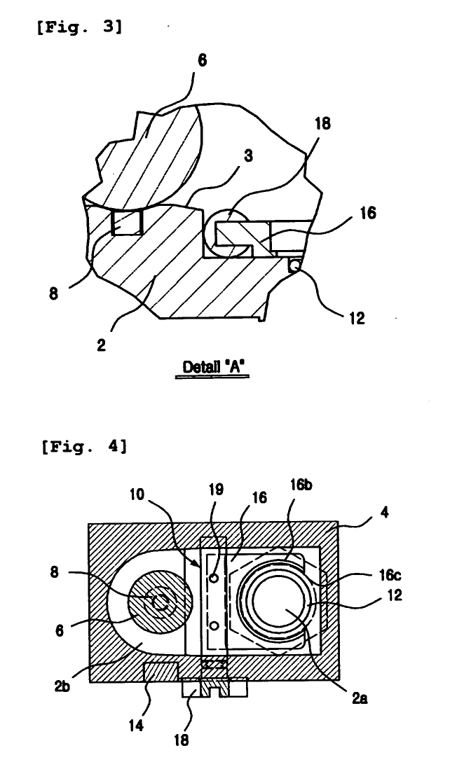

FIG. 1 is perspective view illustrating a valve to shut off flow passage by sensing an earthquake according to the first embodiment of the present invention; FIG. 2 is a front cross-sectional view of FIG. 1; FIG. 3 is an enlarged cross-sectional view for showing in detail the construct of “A” shown in FIG. 2; FIG. 4 is a top cross-sectional view taken along the broken line A-A in FIG. 1; and FIG. 5 is a top cross-sectional view taken along the broken line B-B in FIG. 1.

As shown in FIGS. 1 to 5, the valve to shut off a flow passage by sensing an earthquake and overflowing gas according to a first embodiment of the present invention comprises a valve body 2, a lid 4, an inertia ball 6, a cylindrical magnet 8, a reset unit 10 and a rubber magnetic ring 12. The valve body 2 has an outlet 2a of a flow passage, which is perpendicularly penetrated at a lower portion thereof, and an inner space 2b between an inlet 4a and the outlet 2a. The inner space 2b has a stepped portion in which the outlet 2a is low. The upper side of the stepped portion has the downward inclined plane 3 in the gas outlet direction as the predetermined angle so that the inertia ball 6 is guided to the outlet 2a. The lid 4 includes the inlet 4a, which is protruded from an upper surface of the valve body 2. The inertia ball 6 is positioned on a bottom of the inner space 2b of the valve body 2 in a normal state. The inertia ball 6 shuts off the outlet 2a by moving to and seating on it, when the earthquake shock or the vibration of the predetermined magnitude is generated. The cylindrical magnet 8 is buried into the bottom of the inner space 2b of the valve body 2 and supports the inertia ball 6 through its magnetic force. The reset unit 10 is configured in the inner space 2b of the valve body 2 and gets back the inertia ball 6 from the closing position of the outlet 2a of valve body 2. The rubber magnetic ring 12 is configured on an inner circumference of the outlet 2a to maintain air tightness between the inertia ball 6 and the outlet 2a.

The reset unit 10 comprises a bracket 16 having a circular hole 16a for settling the inertia ball 6, and the lever 18 crossing toward the stepped portion edge of the inner space 2b from the outward appearance of the valve body 2 and is mounted. The lever 18 has a slot for inserting the bracket 16. The end part of the bracket 16 is inserted in the slot of the lever 18 and is fixed with a bolt 19.

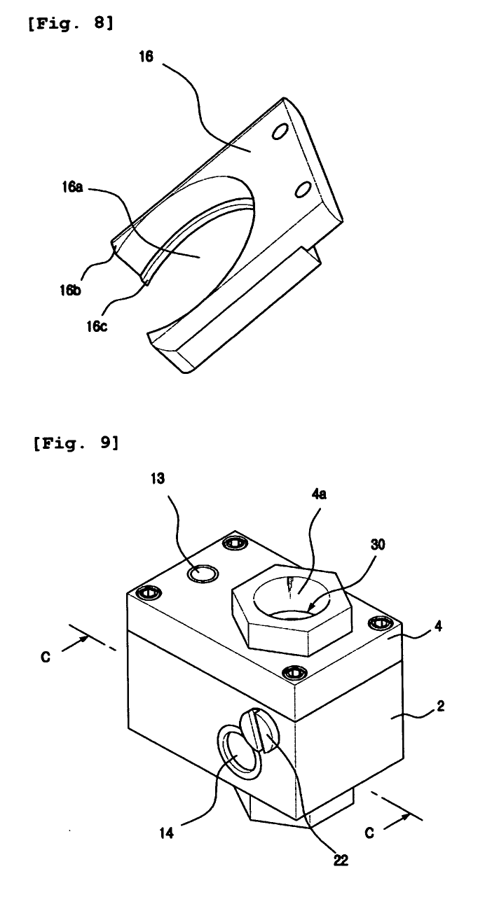

FIG. 8 shows the bracket 16 of the reset unit 10. As shown in FIG. 8, the first and the second jaw 16b and 16c are formed in circumferential surface of the circular hole 16a of the bracket 16. The diameter of the first jaw 16b is larger then that of the inertia ball 6 and the second jaw 16c is smaller then that of the inertia ball 6 on the other hand. The first jaw 16b becomes the form which is surrounding the exterior of the inertia ball 6 to be greater than the diameter of the inertia ball 6. The first jaw 16b gets to do the case role of the inertia ball 6 and the inertia ball 6 gets to be thrown on the second jaw 16c.

Thus, after the inertia ball 6 blocks the outlet 2b, although the additional vibration is generated, the thing in which the inertia ball 6 breaks away from is prevented. The intensity to make the inertia ball 6 go away from the cylindrical magnet 8 is adjustable by controlling a magnetic field with its intensity and size. The cylindrical magnet 8 can be replaced with an inertia ball recess. The recess is configured to make the inertia ball 6 go away from the secured position over a predetermined slant. The radius of the recess is identical with that of the inertia ball 6. Also, the intensity to make the inertia ball 6 go away from the recess is adjustable by controlling the radius and depth of the recess.

In addition, a level 13 is installed on an upper surface of the valve body 2 to check the closed state of the outlet 2a and a perspective window 14 is installed at a front surface of the valve body 2 to check its horizontal state. The level 13 and the perspective window 14 can be installed in all embodiments of the present invention.

Hereinafter, the operation according to the first embodiment of the present invention will be described in detail.

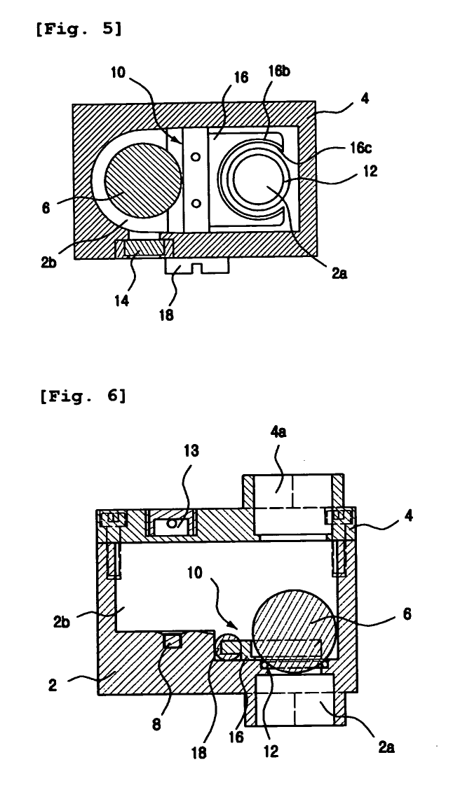

FIG. 6 is a cross-sectional view showing the inertia ball 6 to shut off the outlet 2a of the valve body 2 by sensing an earthquake according to the first embodiment of the present invention.

Referring to again FIG. 2, the inertia ball 6 clings to the bottom of the inner space 2b of the valve body 2 by a magnetic force of the cylindrical magnet 8 in a normal state. As shown in FIG. 6, the inertia ball 6 goes away from the cylindrical magnet 8, when a vibration or an earthquake shock of the predetermined magnitude is generated. The inertia ball 6 is induced to the gas outlet 2a with the incline 3 of the inner space 2b. The inertia ball 6 is settled and fixed in the second jaw 16b, 16c with the first of the bracket 16. At this time, the inertia ball 6 shuts off the outlet 2a with maintaining the air tightness with the rubber magnet ring 12.

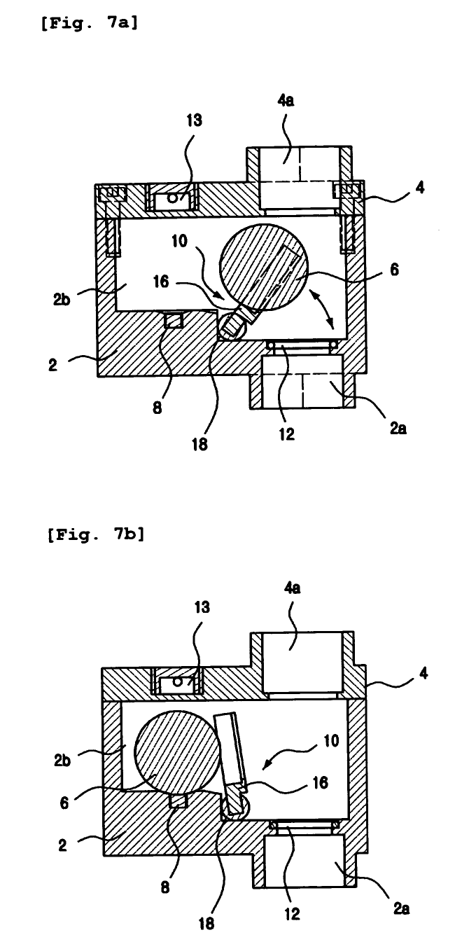

FIGS. 7a and 7b are cross-sectional views illustrating a restore process to return the inertia ball to an original position. As shown in FIGS. 7a and 7b, as the lever 18 is rotated, the bracket 16 rotates and the inertia ball 6 gets to be lifted. If it rotates to the location in which the bracket 16 is stood upright, the inertia ball 6 is broken away from the first jaw 16b and it move to the location of the original. And the inertia ball 6 is clung on the cylindrical magnet 8.

Next, a second embodiment of the present invention will be described in detail referring to FIGS. 9 to 14.

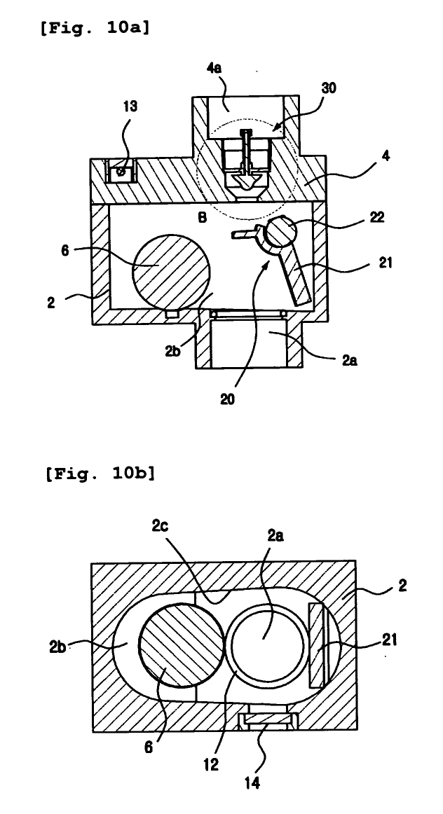

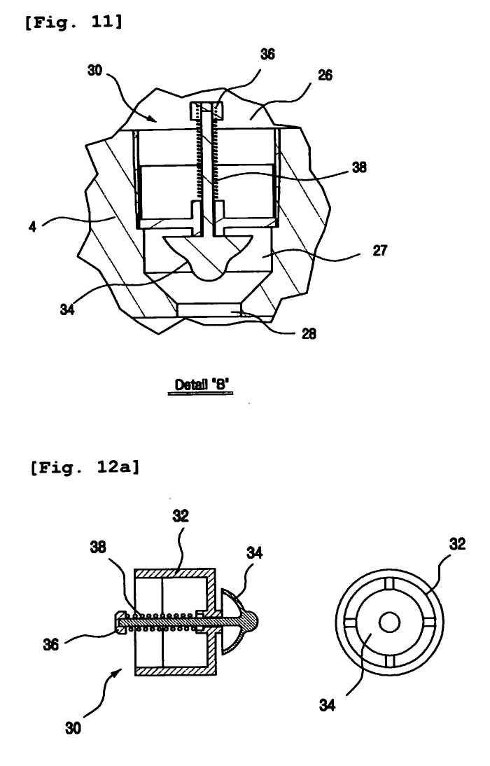

FIG. 9 is a perspective view illustrating a valve to shut off a flow passage by sensing an earthquake and overflowing gas according to a second embodiment of the present invention; FIG. 10a is a front cross-sectional view for illustrating the second embodiment of the present invention; FIG. 10b is a top cross-sectional view taken along the broken line C-C in FIG. 9; and FIG. 11 is an enlarged cross-sectional view for showing in detail the structure of B in FIG. 10.

The second embodiment of the present invention is to add an overflowing gas stopping unit to the above mentioned structure of the earthquake safety valve of the first embodiment. The detailed description of the earthquake safety valve in this embodiment will be omitted because the structure of the earthquake safety valve is the same as that in the above-mentioned first embodiment. The same reference numerals denote the same elements as illustrated in the first embodiment.

As shown in FIG. 10a, the reset unit 20 comprises a bracket 21, which is composed of a horizontal plate and a vertical plate and a round portion, wherein the round portion is formed in a type of a round section and joins the ends of the horizontal plate and the vertical plate at an angle of 90°. The reset unit 20 further comprises a lever 22 which is installed at the round portion of the bracket 21 and which passes though the valve body 2 to rotate the bracket 21. The horizontal plate of the bracket 21 prevents the inertia ball 6 seated on the outlet 2a from going away from the outlet 2a by continuous vibrations after the inertia ball 6 closes the outlet 2a.

As shown in FIG. 10b, the bottom of the inner space 2b in the valve body 2 is downwardly slanted to the outlet 2a in order that the inertia ball 6, which is fixed by a magnetic force, moves toward the outlet 2a. Also, the breadth of the side wall 2c of the body 2 is narrower than that of the outlet 2a.

Based on such the inner space structure of the present invention, the inertia ball 6 leaves a seated position of the cylindrical magnet 8 and then it goes toward the outlet 2a when the vibration or the earthquake shock of the predetermined magnitude is applied to the valve body 2. At this time, the side wall 2c of the inner space 2b guides the inertia ball 6 to the outlet 2a.

As shown in FIGS. 10a and 11, The gas inlet 4a of the lid 2 consists of a first hole 26, a second hole 27 and a third hole 28 in a three-stair structure wherein the diameter of the holes 26, 27 and 28 are getting narrower respectively. That is, the diameter of the first hole 26 is wider than that of the second hole 27 and the diameter of the second hole 27 is wider than that of the third hole 28. An end of the third hole 28 is chamfered in a cone-section. An overflowing gas stopping unit 30 is provided in the second hole 27 and the third hole 28 and works to shut off the inlet 4a when the overflowing gas is caused by an abnormal increase in the gas pressure.

The overflowing gas stopping unit 30 comprises a cylindrical case 32, a blocking member 34, a plug 36 and a first spring 38. The cylindrical case 32 is inserted into the second hole 27. The blocking member 34 is of a cone shape of which an end has a round surface (similar to a hemisphere; however, it is possible to employ other shapes capable of closing the inlet 4a). An area of the blocking member 34 is larger than that of the third hole 28 at one side thereof and a bar passing through the cylindrical case 32 is formed at the other side thereof so that the blocking member 34 opens or blocks the inlet 4a by the gas pressure. The plug 36, which is installed outside of the cylindrical case 32 and joined with the bar of the blocking member 34, prevents the blocking member 34 from leaving the cylindrical case 32. The first spring 38 surrounds the bar of the blocking member 34. The first spring 38 is extend, when the gas flow excessively in an abnormal state, and is restored to make the blocking member 34 disposed at an original position when the gas flows in a normal state.

Hereinafter, the operation according to the second embodiment of the present invention will be described in detail.

Referring to again FIG. 10a, the inertia ball 6 clings to the bottom of the inner space 2b of the valve body 2 by a magnetic force of the cylindrical magnet 8 in a normal state. As shown in FIG. 10b, the inertia ball 6 goes away from the cylindrical magnet 8, when a vibration or an earthquake shock of the predetermined magnitude is generated. The inertia ball 6 goes away from the cylindrical magnet 8 to the outlet 2a due to the structure of the inner space 2b which has both the slant bottom and the tapered side wall 2c toward the outlet 2a. The inertia ball 6 seats on and shuts off the outlet 2a and is firmly secured on it by the rubber magnet ring 12 which is configured around it.

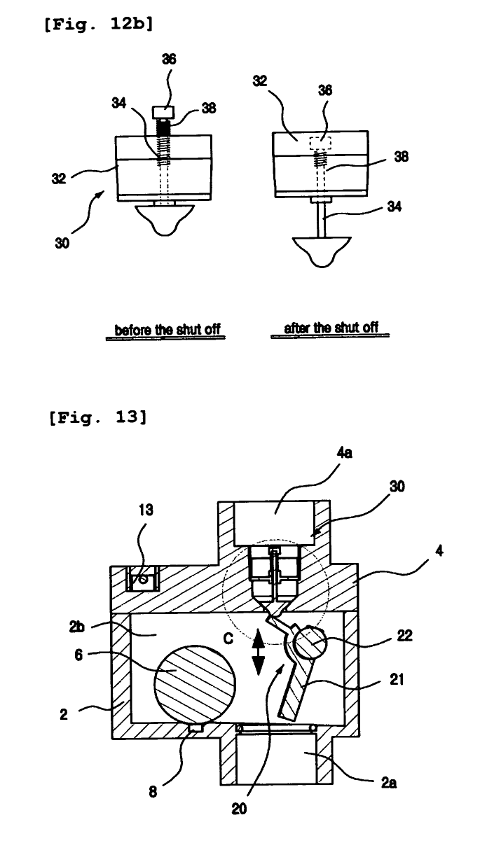

FIG. 12a is a cross-sectional view illustrating a blocking member; and FIG. 12b is a schematic view illustrating the operation of the blocking member 34 in the overflowing gas stopping unit 30. In FIG. 12b, the left picture shows the operation of the overflowing gas stopping unit 30 in a normal state and the right picture shows the operation of it after the gas overflow.

As shown in FIG. 11 and the left picture of FIG. 12b, the hemisphere of the blocking member 34 is pulled up from the cylindrical case 32 by a compressed force of the first spring 38 in a normal state so that the inlet 4a of the lid 4 is opened. However, it can be regarded as an abnormal state when an excessive amount of gas, which is over a regulated flow of the pressure regulator (not shown), is exhausted by a cutting or damage of the tube. In this abnormal state, the gas is rapidly leaked out through the penetrated hole of the cylindrical case 32 and a gap between the case 32 and the second hole 27.

In the event that the pressure difference between the inlet side and the outlet side due to the gas leakage over a regulated pressure gets over the tension of the first spring 38, the pressure difference moves down the hemisphere of the blocking member 34, getting over the resistant power of the first spring 38. Thus, the hemisphere of the blocking member 34 shuts off the inlet 4a to prevent the overflowing gas from leaking.

Next, after the overflowing gas is shut off, a restore process to return the blocking member 34 to an original position in a normal flow state will be described referring to FIGS. 13 and 14.

FIG. 13 is a cross-sectional view illustrating a state, after a reset unit is worked, in the second embodiment of the present invention and FIG. 14 is an enlarged cross-sectional view for showing in detail the structure of “C” shown in FIG. 13.

As shown in FIG. 13, the blocking member 34 closes the third hole 28 based on the operation of the overflowing gas stopping unit 30. Thereafter, an accident part is replaced with new one (for example, cutting parts of the gas hose or other parts to cause the overflow are replaced with normal parts). The bracket 21 is rotated through a manual operating of the lever 22. The upper plate of the bracket 21 pushes up the hemisphere of the blocking member 34 upwardly so that the hemisphere of the blocking member 34 is returned in an original position. The lever 22 is then rotated counter clockwise to return the bracket 21 to the original position.

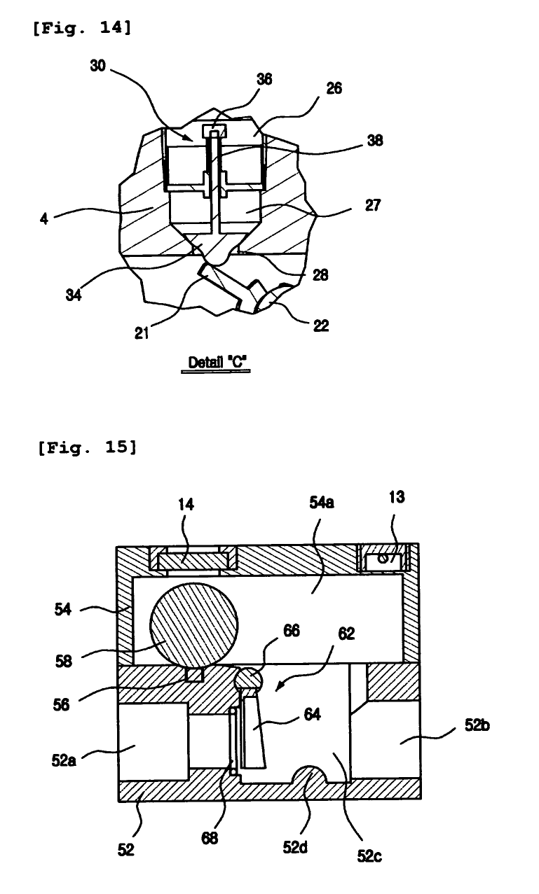

Next, a third embodiment of the present invention will be described in detail referring to FIGS. 15 to 18.

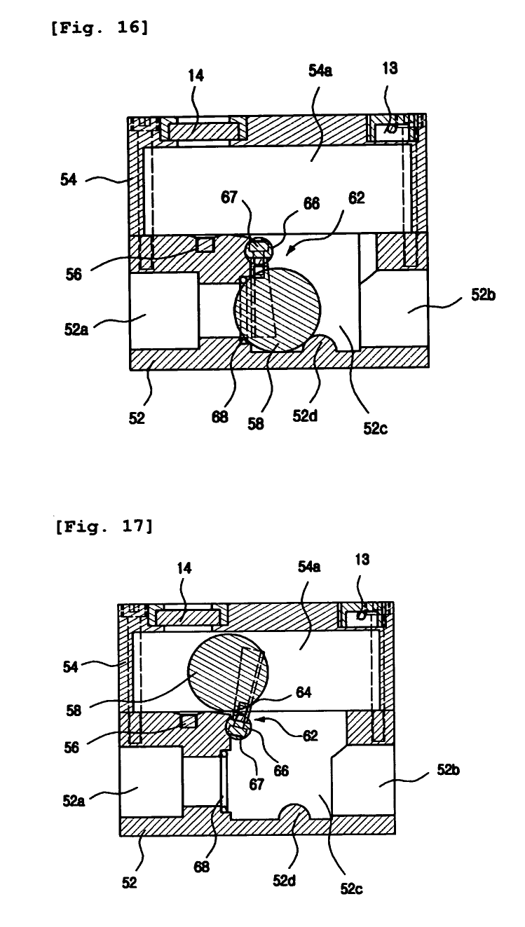

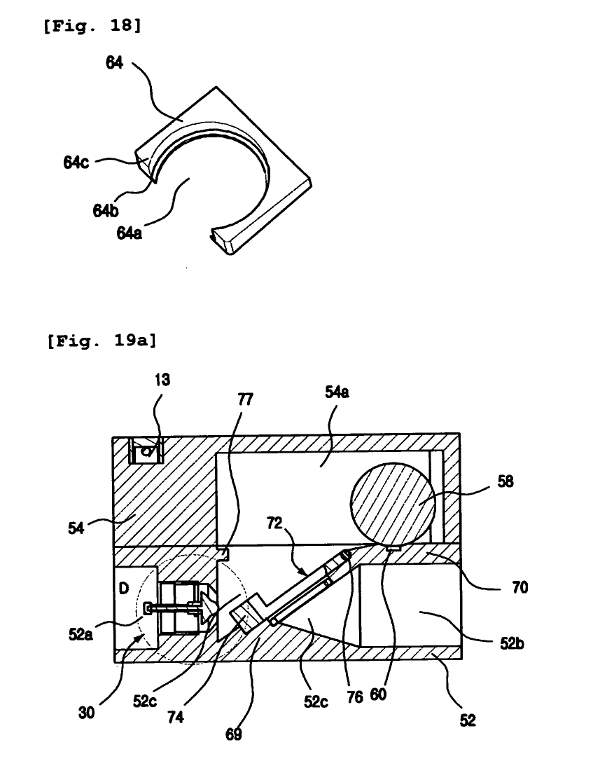

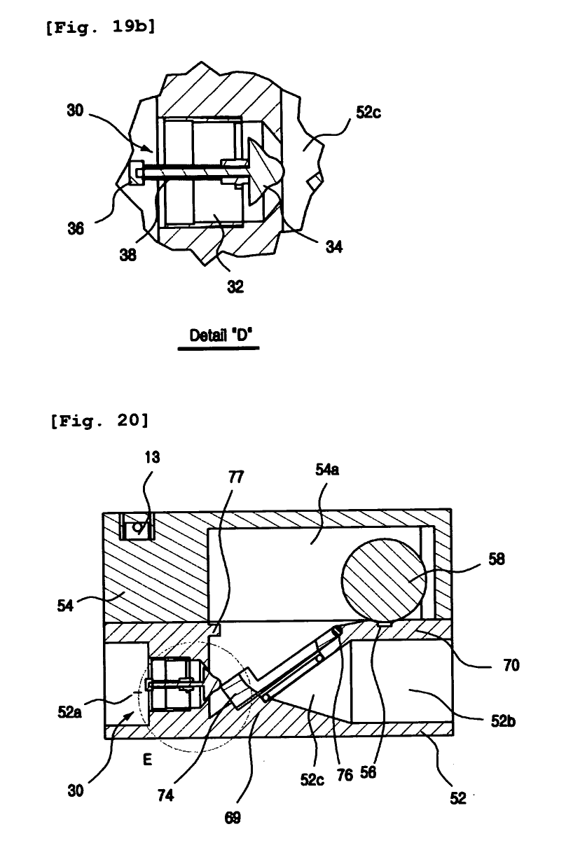

FIG. 15 is a cross-sectional view illustrating a state, before an inertia ball 58 shuts off a flow passage 52, according to the third embodiment of the present invention; FIG. 16 is a cross-sectional view illustrating a state, after the inertia ball 58 shuts off the flow passage 52, according to the third embodiment of the present invention; FIG. 17 is a cross-sectional view illustrating a reset state in which a reset unit 62 returns the inertia ball 58 to an original position according to the third embodiment of the present invention; and FIG. 18 is a perspective view for illustrating a structure of a bracket 64 in the third embodiment of the present invention. The third embodiment of the present invention is utilized in an earthquake safety valve of a horizontal type.

As shown in FIGS. 15 to 18, a valve to shut off a flow passage by sensing an earthquake and a gad overflow according to the third embodiment of the present invention comprises a valve body 52, a lid 54, a cylindrical magnet 56, an inertia ball 58, a reset unit 62 and O-ring 68. The valve body 52 has an inlet 52a, an outlet 52b penetrated horizontally and a flow passage 52c formed between the inlet 52a and the outlet 52b. The flow passage 52c of the valve body 52 is formed with a protrusion 52d of the sphere shape on the bottom thereof. The lid 54 is installed on the valve body and has a working room 54a therein, wherein the working room 54a connects to the flow passage 52c of the valve body 52. The cylindrical magnet 56 is buried on the upper side of the valve body 52 to hold the inertia ball 58. The inertia ball 58 is positioned on the cylindrical magnet 56 and shuts off the flow passage 2c. The inertia ball 58 moves toward a protrusion 52d of the flow passage 52c and shuts off the flow passage 52c, when an earthquake shock or a vibration of the predetermined magnitude is generated. The protrusion 52d prevents from the inertia ball 58 breaking away from shut off position of the flow passage 52c, when the additional vibration is generated after the inertia ball 58 blocks the flow passage 2c. The reset unit 62 is vertically installed in one side wall of the path in which the flow passage 52c of the valve body 52 and inner space 54a of the lid 54 are put through in the vertical direction to get back the inertia ball 58 from the closing position of the flow passage 52c. The O-ring 68 is configured on an inner circumference of the flow passage 2c to improve air tightness between the inertia ball 6 and the flow passage 2c. The reset unit 62 comprises a bracket 64 having circular hole 64a for settling the inertia ball 58; the lever 66 crossing toward one side wall of the flow passage 52c from the outward appearance of the valve body 2 and is mounted and a bolt 67 for fixing the bracket 64 to lever 66. The lever 66 has a slot for inserting the bracket 64. The end part of the bracket 64 is inserted in the slot of the lever 66 and is fixed with a bolt 67.

FIG. 18 shows the bracket 64 of the reset unit 10. As shown the FIG. 18, the first and the second jaw 64b and 64c are formed in circumferential surface of the circular hole 64a of the bracket 64. The diameter of the first jaw 64b is larger then that of the inertia ball 58 and the second jaw 64c is smaller then that of the inertia ball 58.

Hereinafter, the operation according to the third embodiment of the present invention will be described in detail.

As shown in FIG. 15, the inertia ball 58 clings to the cylindrical magnet 56 before it shuts off the flow passage 52c of the valve body 52. The bracket 64 of the reset unit 62 cross and position the flow passage 52c. In this state, the gas passes through the circular hole 64a of the bracket 64 and is exhausted to the outlet 52b.

As shown in FIG. 16, the inertia ball 58 is released from the cylindrical magnet 60 and seated on the circular hole 64a of the bracket 64, when the earthquake shock or the vibration of the predetermined magnitude is generated, so that the flow passage 52c of the valve body 52 is shut off to prevent the gas from leaking.

As shown in FIG. 17, in the event that the inertia ball 58 moves from the closed position of the flow passage 52c to its original position, the bracket 64 upwardly rotates by the rotation of the lever 66. The inertia ball 58 rolls to upper side of the valve body 52 by its own weight and clings to the cylindrical magnet 60.

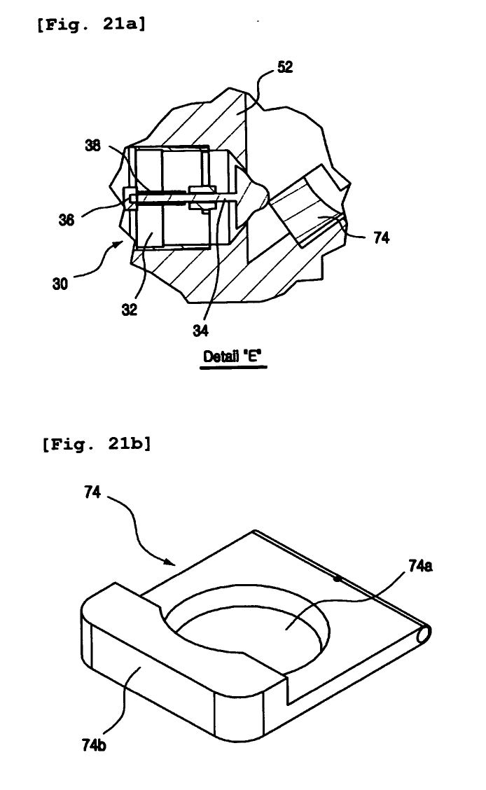

Next, a fourth embodiment of the present invention will be described in detail referring to FIGS. 19 to 21.

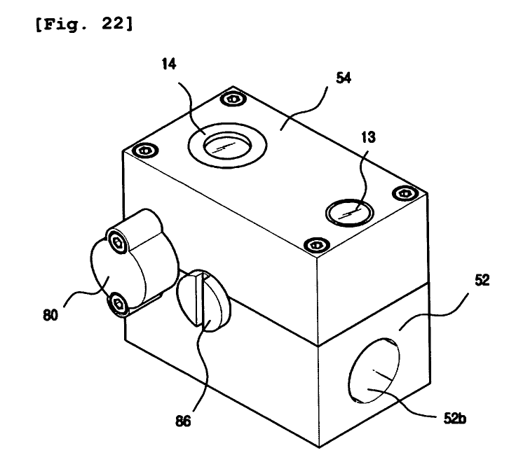

FIG. 19a is a cross-sectional view illustrating a state, before the overflowing gas stopping unit 30 shuts off an inlet 52a, according to a fourth embodiment of the present invention; FIG. 19b is an enlarged cross-sectional view for showing in detail the structure of “D” shown in FIG. 19a; FIG. 20 is a cross-sectional view illustrating a state, after the overflowing gas stopping unit 30 shuts off the inlet 52a, according to the fourth embodiment of the present invention; FIG. 21a is an enlarged cross-sectional view for showing in detail the structure of “E” shown in FIG. 20; FIG. 21b is a perspective view for illustrating a structure of a bracket in the fourth embodiment of the present invention.

The fourth embodiment of the present invention is to add an overflowing gas stopping unit 30 to the above mentioned structure of the earthquake safety valve of the second embodiment. The overflowing gas stopping unit 30 according to the fourth embodiment is the same as that of the overflowing gas stopping unit in the second embodiment. The fourth embodiment differs from the second embodiment in a horizontal installing location. Referring now to FIGS. 19 to 21, the detailed description of the earthquake safety valve will be omitted because the overflowing gas stopping unit 30 has been described in the above-mentioned second embodiment.

As shown in FIG. 19a, the flow passage 52c of the valve body 52 is formed with a protrusion 69 having a predetermined height on the bottom thereof. A middle plate 70 is installed over an upper side of the outlet 52b of the valve body 52 to separate the working room 54a from the outlet 52b, wherein the middle plate 70 covers a part of the working room 54a of the lid 54. The reset unit 72 is installed between the protrusion 69 and the middle plate 70. The reset unit 72 comprises a bracket 74, one end of which is connected to an end of the middle plate 70 and the other end of which is hung on the protrusion 69, wherein the bracket 74 have a hole 74a to seat the inertia ball 58 in the middle portion thereof and a stair portion 74b protruded at a lower portion thereof to support the inertia ball 58 seated on the hole 74a; a lever 76 passing through a connection part of the bracket 74 and the middle plate 70 to rotate the bracket 74. The stair portion 74b of the bracket 74 has a concave rounding portion of which diameter is equal to that of the inertia ball 58.

A guide plate 77 conducts the inertia ball 58 to the hole 74a of the bracket 74, which is protrude from an upper end of the inlet 52a and has a concave in the middle thereof.

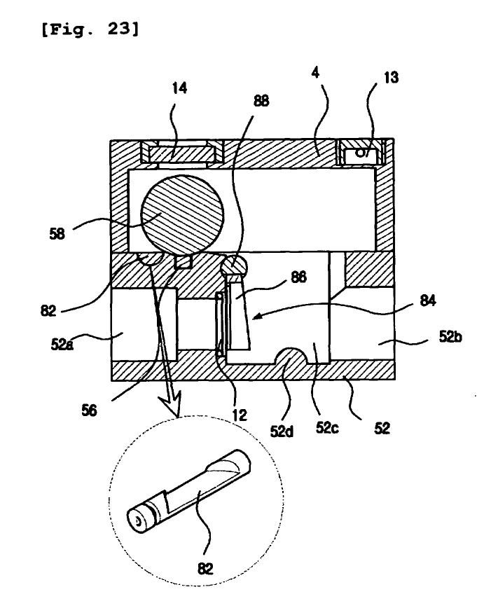

Next, a fifth embodiment of the present invention will be described in detail referring to FIGS. 22 to 26.

According to the fifth embodiment of the present invention, it is to shut off the outlet 52a through the movement of the inertia ball 58 which is moved by a clockwise and counter clockwise geared motor 80. In the fifth embodiment of the present invention, the same reference numerals denote the same elements as illustrated in the third embodiment. Thus, the detailed illustration of these structures will be omitted and the rest of the structure will be described in detail.

FIG. 22 is a perspective view illustrating a valve to shut off a flow passage by sensing an earthquake according to the fifth embodiment of the present invention and FIG. 23 is for illustrating a normal state in which the gas flows under the regulated pressure as a front cross-sectional view according to the fifth embodiment of the present invention.

According to the fifth embodiment of the present invention, a geared motor 80 clockwise or counter clockwise works based on an electrical signal from a gas alarm (not shown), which is installed at an external side of the valve body 52. An eccentric shaft 82 in a type of half circle rotates to move the inertia ball 58 toward the outlet 52b, located nearby the cylindrical magnet 56 and connected to a shaft of the geared motor 80, wherein the eccentric shaft 82 is buried in the upper side of the valve body 52. A reset unit 84 is positioned in the flow passage 52c and gets back the inertia ball 58 from the closing position of the flow passage 52c of the valve body 52.

The reset unit 84 comprises a bracket 86 and a lever 88. The lever 88 goes through the valve body 52 and functions as a pivot. The bracket 86, which is supported on an axis of the lever 88, gets back the inertia ball 58 from the closing position of the flow passage 52c of the valve body 52.

Hereinafter, the operation of the fifth embodiment of the present invention will be described referring to FIGS. 23 to 26.

FIGS. 23 to 26 show a gas blocking mechanism in which the inertia ball 58 moves to a position to shut off the outlet 52b from an original position of a normal state under the regulated pressure.

As shown in FIG. 23, the inertia ball 58 clings to the cylindrical magnet 56 and the flow passage 52c is opened in order that the gas from the inlet 52a flows to the outlet 52b.

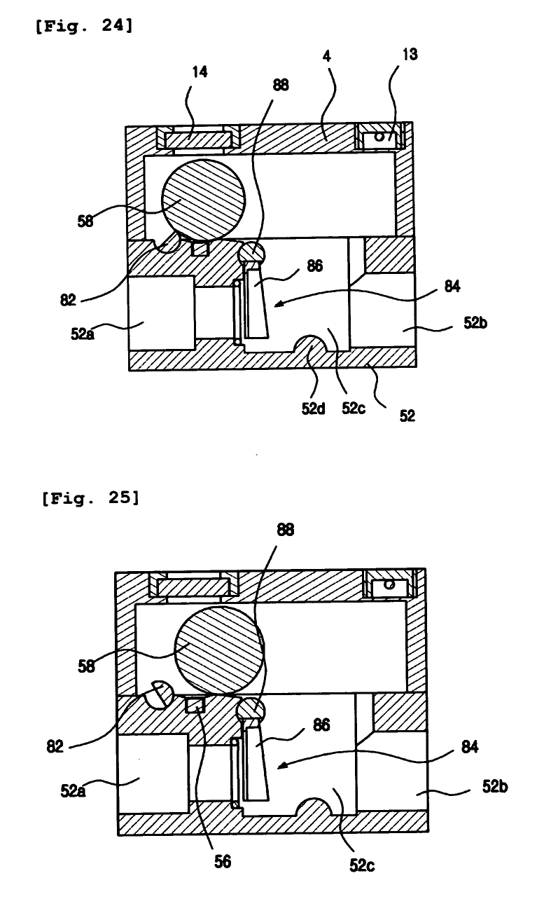

FIG. 24 is a cross-sectional view illustrating the eccentric shaft 82 which works to release the inertia ball 58. As shown in FIG. 24, the geared motor 80 is employed and rotated by an electrical signal from the gas alarm. The eccentric shaft 82 rotates about 60 degree with the rotation of the geared motor 80 to push and release the inertia ball 58 from the cylindrical magnet 56.

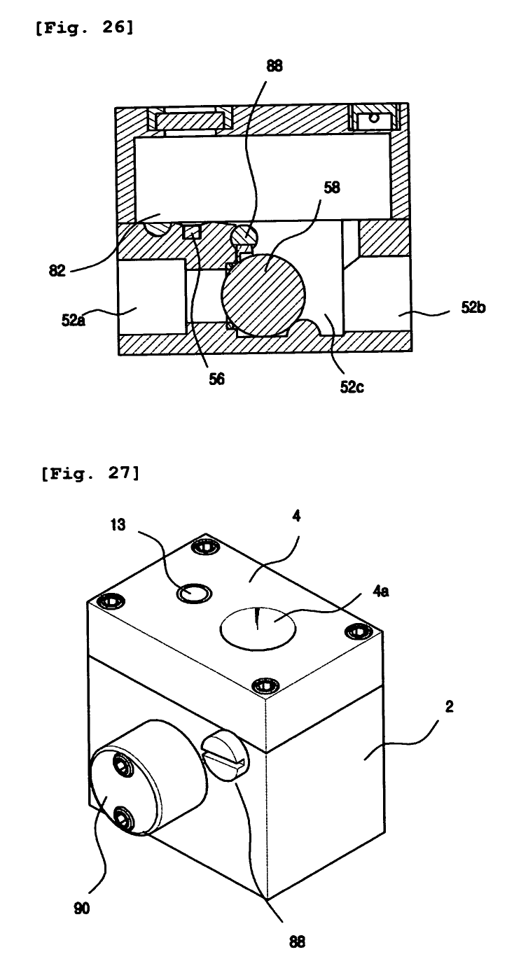

FIG. 25 shows that the inertia ball 58 is moving toward the flow passage 52b and FIG. 26 shows that the operation of the reset unit 84 in a state in which the flow passage 52c is shut off by the inertia ball 58.

As shown FIGS. 25 and 26, the inertia ball 58 is rolled and seated toward the flow passage 52c so that the gas is prevented from leaking. After the earthquake shock or the vibration of the predetermined magnitude is over, the bracket 86 turns and pushes the inertia ball 58 when the lever 88 is rotated by a manual operation so that the inertia ball 58 gets back from the closing position of the outlet 52b.

Next, the sixth embodiment of the present invention will be described referring to FIGS. 27 to 31.

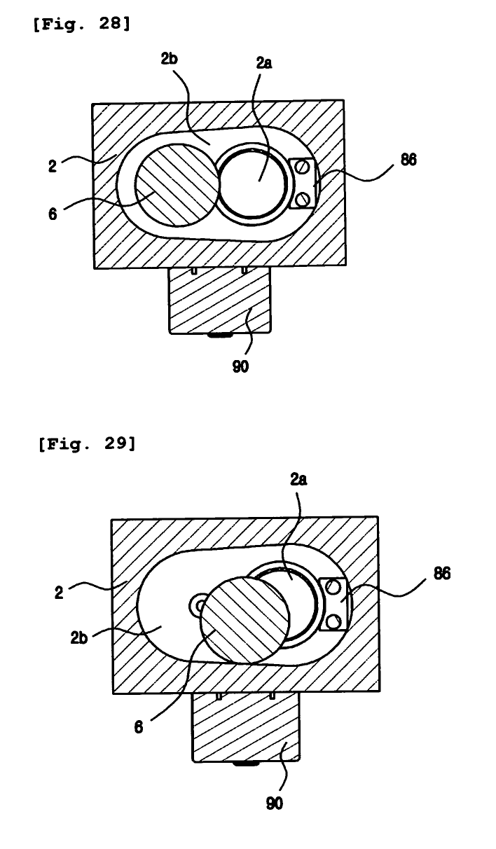

FIG. 27 is a perspective view illustrating a valve to shut off a flow passage by sensing an earthquake according to the sixth embodiment of the present invention; FIG. 28 is a top cross-sectional view in FIG. 27 and FIGS. 29 to 31 are cross-sectional views illustrating a gas blocking mechanism in which an inertia ball moves to a position to shut off an outlet from an original position of a normal state in which the gas flows under the regulated pressure.

The structure of the sixth embodiment of the present invention is the same as that of the second embodiment, except for a solenoid 90 for moving the inertia ball 6. A solenoid 90 is employed on an outside of the valve body 2, instead of the geared motor 80. An electrical signal from the gas alarm is applied to the solenoid 90 and the solenoid 90 shuts off the outlet 2a in response to the electrical signal.

FIGS. 28 to 31 are cross-sectional views illustrating a gas blocking mechanism in which the inertia ball 6 moves to a position to shut off the outlet 2a from an original position of a normal state in which the gas flows under the regulated pressure.

FIG. 28 is a cross-sectional view illustrating a normal state in which the gas flows under the regulated pressure and FIGS. 29 to 31 are cross-sectional views illustrating a gas blocking mechanism in which an inertia ball moves to a position to shut off an outlet from an original position of a normal state in which the gas flows under the regulated pressure. FIG. 29 shows the operation when the power is applied to the solenoid 90. As shown in FIG. 28, the inertia ball 6 clings to the cylindrical magnet 8 and the flow passage is opened in order that the gas from the inlet 4a flows to the outlet 2a. At this time, the power is not applied to the solenoid 90.

If the power is applied to the solenoid 90, the solenoid 90 generates an electromagnetic force. The inertia ball 6 is released from the cylindrical magnet 8 by the electromagnetic force and moves to a side wall and eventually to the solenoid 90 as shown in FIGS. 28 and 29.

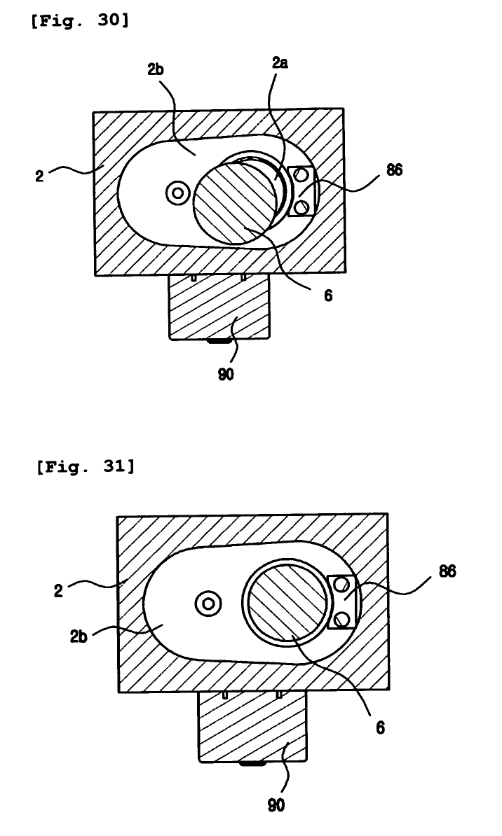

Referring to FIGS. 30 and 31, the inertia ball 6 positioned on the side wall still moves toward the outlet while the power is not applied to the solenoid 90 any more. The inertia ball 6 is rolled and finally seated into the outlet 2a from the side wall. After the earthquake shock or the vibration of the predetermined magnitude is over, the bracket 16 turns and pushes the inertia ball 6, when the lever 18 is rotated by a manual operation, so that the inertia ball 6 get back from the closing position of the outlet 2a.

Although the preferred embodiments of the invention have been disclosed for illustrative purposes, those skilled in the art will appreciate that various modifications, additions and substitutions are possible, without departing from the scope and spirit of the invention as disclosed in the accompanying claims.

As apparent from the present invention, the valve automatically shuts off the inlet or the outlet of the gas system by sensing the vibration or the earthquake shock through a mechanical working so that an accident caused by the gas leakage is preliminarily prevented. Also, the valve automatically closes the inlet or the outlet of the flow passage through a mechanical working based on the fluctuation of the pressure, when the gas exhausted from the gas supply source excessively flows over the regulated amount in an abnormal state.

What is claimed is:

1. An earthquake safety valve to sense an earthquake and overflowing gas and shut off a flow passage comprising:
a valve body having an inlet and an outlet of gas and an inner space formed between the inlet and the outlet;
an inertia ball positioned on a bottom of the inner space of the valve body in a normal state and moving to the outlet in order to shut off the outlet when the earthquake or a vibration of the predetermined magnitude is generated;
a supporting member for supporting the inertia ball on the bottom of the inner space of the valve body;
a reset means provided in the inner space of the valve body to get back the inertia ball from a shut-off position of the outlet; and
an overflowing gas stopping unit installed in the inlet of the valve body to close the inlet based on an overpressure of gas flow, when the gas flow is exhausted over a regulated amount from a gas supply source.

2. The earthquake safety valve in accordance with claim 1, wherein the inlet of the valve body consists of a first hole, a second hole and a third hole in a three-stair structure, wherein a diameter of the first hole is wider than that of the second hole and a diameter of the second hole 24 is wider than that of the third hole.

3. The earthquake safety valve in accordance with claim 2, wherein the overflowing gas stopping unit includes:
a cylindrical case inserted into the second hole;
a blocking member in a shape of cone which area is larger than that of the third hole at one side thereof, having a bar passing through the cylindrical case at the another side thereof so that the blocking member opens or shuts off the inlet through a movement based on the gas flowing pressure;
a plug installed at one end of the bar of the blocking member to prevent the blocking member from being released from the cylindrical case; and
a first spring surrounding the bar of the blocking member and extended when the gas flow is excessively increased in an abnormal state and making the blocking member disposed at an original position when the gas flow is in a normal state.

4. The earthquake safety valve in accordance with claim 1, wherein the inner space of the valve body has a stepped portion in which the outlet is low and the upper side of the stepped portion has the downward inclined plane in the outlet direction as the predetermined angle so that the inertia ball be guided to the outlet.

5. The earthquake safety valve in accordance with claim 1, wherein the bottom of the inner space is downwardly slanted to the outlet in order to make the inertia ball move to the outlet as soon as the inertia ball is released from the cylindrical magnet and wherein a breadth of the side wall of inner space becomes wider toward the outlet.

6. The earthquake safety valve in accordance with claim 1, further comprising a rubber magnetic ring installed on an inner circumference of the outlet of the valve body to improve a sealing capability between the inertia ball and the outlet.

7. The earthquake safety valve in accordance with claim 1, wherein the reset means includes:
a bracket is installed on floor side of the stepped portion floor side, which has a circular hole for settling the inertia ball moved to the outlet;
a lever having a slot formed into the longitudinal direction and crossing toward the stepped portion edge of the inner space from the outward appearance of the valve body 2 and is mounted; and
a bolt for fixing the bracket to the lever.

8. The earthquake safety valve in accordance with claim 7, further comprising the first and the second jaw are formed in the circumference surface of the circular hole of the bracket, wherein the diameter of the first jaw is larger then that of the inertia ball and the diameter of the second jaw is smaller then that of the inertia ball.

9. The earthquake safety valve in accordance with claim 1, wherein the reset means includes:
a bracket installed in the inner space of the valve body, having a horizontal plate and a vertical plate and a round portion, which is formed in a type of a round section, and joining each ends of the horizontal plate and the vertical plate at an angle of 90°; and
a lever passing though the valve body and joined with the round portion of the bracket in order to rotate the bracket.

10. The earthquake safety valve in accordance with claim 1, wherein the supporting member is a cylindrical magnet which is buried into the bottom of the inner space.

11. The earthquake safety valve in accordance with claim 1, wherein the supporting member is an inertia ball recess which is formed at the bottom of the inner space.

12. The earthquake safety valve in accordance with claim 10, wherein the intensity of the cylindrical magnet for separating the inertia ball is controlled with the magnetic field intensity and size of that.

13. The earthquake safety valve in accordance with claim 1, further comprising a perspective window installed in a front surface
of the valve body to check the closed state of the outlet and a level installed on an upper surface of the valve body to check the horizontal state of the valve body.

14. An earthquake safety valve to sense an earthquake and overflowing gas and shut off a flow passage comprising:
a valve body having an inlet and an outlet of gas and an inner space formed between the inlet and the outlet;
a lid installed on the valve body and having a working room to put through with the inner space therein;
an inertia ball positioned on the upper side of the valve body, moving to the outlet in order to shut off the outlet when the earthquake or a vibration of the predetermined magnitude is generated;
a supporting member for supporting the inertia ball on the upper surface of the valve body;
a reset means vertically installed in one side wall of the path in which the flow passage of the valve body and inner space of the lid are put through in the vertical direction to get back the inertia ball from the closing position of the flow passage; and
an overflowing gas stopping unit installed in the inlet of the valve body to close the inlet based on an overpressure of gas flow, when the gas flow is exhausted over a regulated amount from a gas supply source.

15. The earthquake safety valve in accordance with claim 14, further comprising a protrusion formed on the bottom of the flow passage of the valve body.

16. The earthquake safety valve in accordance with claim 14, wherein the reset means includes:
a bracket is installed in one side wall of the path, which has a circular hole for settling the inertia ball moved to the flow passage;
a lever having a slot formed into the longitudinal direction and crossing toward the flow passage from the outward appearance of the valve body and is mounted; and
a bolt for fixing the bracket to the lever.

17. The earthquake safety valve in accordance with claim 16, further comprising the first and the second jaw are formed in the circumference surface of the circular hole of the bracket, wherein the diameter of the first jaw is larger then that of the inertia ball and the diameter of the second jaw is smaller then that of the inertia ball.

18. The earthquake safety valve in accordance with claim 14, wherein the supporting member is a cylindrical magnet which is buried into the upper side of the valve body.

19. The earthquake safety valve in accordance with claim 14, wherein the supporting member is an inertia ball recess which is formed at the upper side of the valve body.

20. The earthquake safety valve in accordance with claim 14, further comprising a circular gasket installed on an inner circumference of the flow passage to maintain airtightness between the inertia ball and the flow passage.

21. The earthquake safety valve in accordance with claim 14, further comprising a perspective window installed on upper one side of the valve body to check the closed state of the outlet and a level installed on an upper other side of the valve body to check the horizontal state of the valve body.

22. An earthquake safety valve to sense an earthquake and overflowing gas and shut off a flow passage comprising:
a valve body having an inlet and an outlet of gas and an inner space formed between the inlet and the outlet;
a lid installed on the valve body and having a working room to put through with the inner space therein;
a middle plate installed over an upper side of the outlet of the valve body to separate the working room from the outlet, wherein the middle plate covers a part of the working room of the lid;
an inertia ball positioned on the bottom of the middle plate and moving to the outlet in order to shut off the outlet when the earthquake or a vibration of the predetermined magnitude is generated;
a recess for supporting the inertia ball on the bottom of the middle plate;
a reset means, one end of which is connected to one end of the middle plate and the other end of which is positioned in the flow passage to get back the inertia ball from a shut-off position of the outlet; and
an overflowing gas stopping unit installed in the inlet of the valve body to close the inlet based on an overpressure of gas flow, when the gas flow is exhausted over a regulated amount from a gas supply source.

23. The earthquake safety valve in accordance with claim 22, further comprising a protrusion formed on the bottom of the flow passage of the valve body.

24. The earthquake safety valve in accordance with claim 22, wherein the reset means includes:
a bracket, one end of which is connected to one end of the middle plate and the other end of which is hung on the protrusion, wherein the bracket has a hole to seat the inertia ball in the middle portion thereof and a stair portion protruded at a lower portion thereof to support the inertia ball seated on the hole; and
a lever passing through both the bracket and the middle plate to rotate the bracket;
wherein the stair portion of the bracket has a concave rounding portion of which diameter is equal to that of the inertia ball.

25. The earthquake safety valve in accordance with claim 24, further comprising a guide plate conducting the inertia ball to the hole of the bracket, wherein the guide plate is protruded from an upper end of the inlet and has a concave in the middle thereof.

26. The earthquake safety valve in accordance with claim 22, wherein the inlet of the valve body consists of a first hole, a second hole and a third hole in a three-stair structure, wherein a diameter of the first hole is wider than that of the second hole and a diameter of the second hole is wider than that of the third hole, wherein the overflowing gas stopping unit includes:
a cylindrical case inserted into the second hole;
a blocking member in a shape of cone which area is larger than that of the third hole at one side thereof, having a bar passing through the cylindrical case at the another side thereof so that the blocking member opens or shuts off the inlet through a movement based on the gas flowing pressure;
a plug installed at an end of the bar of the blocking member to prevent the blocking member from being released from the cylindrical case; and
a first spring surrounding the bar of the blocking member and extended when the gas flow is excessively increased in an abnormal state and making the blocking member disposed at an original position when the gas flow is in a normal state.

27. An earthquake safety valve to sense an earthquake and overflowing gas and shut off a flow passage comprising:
a valve body having an inlet and an outlet of gas and an inner space formed between the inlet and the outlet;
an inertia ball positioned on a bottom of the inner space of the valve body in a normal state and moving to the outlet in order to shut off the outlet when the earthquake or a vibration of the predetermined magnitude is generated;
a magnet installed on the bottom of the inner space, holding the inertia ball through a magnetic force a driving means installed in the inner space of the valve body, moving the inertia ball toward the outlet; and
a reset means installed in the inner space of the valve body, getting back the inertia ball from a shut-off position of the outlet of the flow passage.

28. The earthquake safety valve in accordance with claim 27, further comprising an overflowing gas stopping unit installed in the inlet of the valve body to shut of the inlet by working based on overpressure of gas flow, when the gas flow is exhausted over a regulated amount from a gas supply source.

29. The earthquake safety valve in accordance with claim 27, wherein the driving means includes:
a geared motor clockwise or counter clockwise working by an electrical signal from a gas alarm device, which is installed outside the valve body ; and
an eccentric shaft making the inertia ball move toward the outlet, located nearby the cylindrical magnet and connected to a shaft of the geared motor, wherein the eccentric shaft is buried in the bottom of the inner space.

30. The earthquake safety valve in accordance with claim 27, wherein the driving means is a solenoid which is installed outside the valve body, wherein the solenoid attracts the inertia ball by generating an electromagnetic force through the electrical signal from a gas alarm device and wherein the inertia ball is made roll toward the outlet by its own weight when the electromagnetic force is faded out.

31. The earthquake safety valve in accordance with claim 27, wherein the reset unit includes:
a bracket is installed in one side wall of the path, which has a circular hole for settling the inertia ball moved to the flow passage;
a lever having a slot formed into the longitudinal direction and crossing toward the flow passage from the outward appearance of the valve body and is mounted; and
a bolt for fixing the bracket to the lever.
